(19) United States
(12) Patent Application Publication
(10) Pub. No.: US 2013/0227464 A1
(43) Pub. Date: Aug. 29, 2013

(54) SCREEN CHANGE METHOD OF TOUCH SCREEN PORTABLE TERMINAL AND APPARATUS THEREFOR

(71) Applicant: Samsung Electronics Co., Ltd., (US)

(72) Inventor: Fredrick JIN, Gyeonggi-do (KR)

(73) Assignee: Samsung Electronics Co., Ltd., Gyeonggi-do (KR)

(21) Appl. No.: 13/774,566

(22) Filed: Feb. 22, 2013

(30) Foreign Application Priority Data
Feb. 24, 2012 (KR) 10-2012-0019264

(51) Int. Cl. G06F 3/0485

(52) U.S. Cl. CPC G06F 3/0485
USPC 715/784

(57) ABSTRACT

In a method and apparatus of a touch screen portable terminal, a screen is classified into a first region displaying scrollable contents and a second region displaying non-scrollable contents. The contents of the first region are scrolled to previous or subsequent contents of a contents sequence responsive to a touch drag gesture detected on the second region. The second region may be a favorite shortcuts region of a home screen. Scrolling speed may be set according to moved distance of the touch drag gesture, or a speed of the touch drag gesture.

### CLAIM OF PRIORITY

This application claims the benefit under 35 U.S.C. §119(a) of a Korean patent application filed in the Korean Intellectual Property Office on Feb. 24, 2012 and assigned Serial No. 10-2012-0019264, the entire disclosure of which is hereby incorporated by reference.

### BACKGROUND

1. Technical Field

The present disclosure relates to a screen change method of a touch screen portable terminal and an apparatus therefor.

2. Description of the Related Art

A portable terminal or mobile terminal refers generally to a handheld electronic device that includes a display and communication electronics to obtain contents for image/audio reproduction. Portable terminals such as cell phones, smart phones, electronic schedulers, tablet PCs, e-book readers and personal complex terminals have become necessities of current society, thanks to recent technological advances Portable terminals have developed into important means of information transmission, with new designs constantly evolving Recently, touch screens have been incorporated into many portable terminals to provide an advanced Graphic User Interface (GUI) system.

As is widely known, core functions and values of the mobile marketplace have moved from a conventional voice communication service to a data service based on contents and applications (commonly called “apps”). Modern software platforms for portable terminals provide a variety of application services similar to those of a desktop environment. As a wireless Internet service and a mobile device have a high level of dependence on applications and contents, there is intense competition to generate new and useful functionality.

In general, the software platforms provide a home screen. A home screen is an initial user interface screen of application shortcuts (e.g., selectable icons), widgets, notice/status bars, etc. With the recent proliferation of apps in the marketplace, the typical portable terminal has a large number of apps stored in memory. To provide rapid access to the apps, multiple home screens are generated, each displaying a different set of apps. The software controlling the touch screen enables a user to scroll between the multiple home screens to find and launch a desired app.

FIG. 1 illustrates a process of changing a home screen in a conventional touch screen portable terminal Referring to the screen on the left, if a user touches and flicks an initial home screen (indicated by the circled numeral “1”) in the left direction, the current home screen changes to a next home screen (indicated by the circled numeral “2”). Referring to the screen on the right, if the user touches and flicks the home screen in the right direction thereof, the touch screen portable terminal changes the current screen “2” to the previous home screen “1”. In general, if the user touches and flicks the home screen once, the touch screen portable terminal changes the current home screen to a next or previous home screen once. However, if there are many home screens in a particular device (e.g., up to seven or higher as indicated by the circles representing the home screen number) the user may search a desired home screen by frequently touching and flicking the current home screen. This results in an inconvenience to the user.

### SUMMARY OF THE INVENTION

An aspect of the present invention is to solve at least the above-mentioned problems and/or disadvantages and to provide at least the advantages described below. Accordingly, an aspect of the present invention is to provide a screen change method of quickly changing the current screen to a previous or subsequent screen by a simple touch event in a touch screen portable terminal and an apparatus therefor.

Another aspect of the present invention is to provide a screen change method of easily and quickly changing a screen by only a simple touch operation.

In accordance with an aspect of the present invention, a screen change method of a touch screen portable terminal is provided. The method involves classifying a screen into a first region displaying scrollable contents and a second region displaying non-scrollable contents. The contents of the first region are scrolled to previous or subsequent contents of a contents sequence responsive to a touch drag gesture detected on the second region.

The contents displayed in the first region may comprise application shortcuts and/or widgets of a home screen. The second region may be a region of favorite application shortcuts of a home screen, or a region displaying operating conditions of the portable terminal. The scroll speed may be set proportional to either a moved distance of the touch drag gesture, or a speed of the touch drag gesture. Thus, in a portable terminal having many home screens, a user is able to quickly scroll through the home screens in a single touch drag gesture, rather than multiple touch drag gestures, to reach a desired one of the home screens.

In other embodiments, the first region may be a region displaying data of an application executed in the portable terminal.

A screen change apparatus for a portable terminal in accordance with an embodiment includes a touch screen unit that displays an image and outputs a signal according to touch input. A storage unit stores operations data of the portable terminal. A controller is configured to classify a screen provided through the touch screen unit into a first region displaying scrollable contents and a second region displaying non-scrollable contents and to control scrolling of the scrollable contents to previous or subsequent contents of a contents sequence responsive to a touch drag gesture detected on the second region.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 illustrates a process of changing a home screen in a conventional touch screen portable terminal;

FIG. 2 is a functional block diagram illustrating configuration of a portable terminal according to an embodiment of the present invention;

FIG. 3 is a flowchart illustrating a process of changing a screen according to an embodiment of the present invention;

FIGS. 4A to 4C are example user interface screens according to an embodiment of the present invention;

FIG. 5 is a user interface screen according to another embodiment of the present invention;

FIGS. 6A and 6B are user interface screens illustrating a further embodiment of the present invention;

FIG. 7 is a graph showing scroll speed vs. touch drag distance illustrating a scroll feature according to certain embodiments of the present invention.

### DETAILED DESCRIPTION OF EXEMPLARY EMBODIMENTS

Exemplary embodiments of the present invention will be described herein below with reference to the accompanying drawings. In the following description, well-known functions or constructions are not described in detail to avoid obscuring the invention in unnecessary detail. Also, terms used herein should be understood in the context of the description of the exemplary embodiments Terms used may vary depending on user or operator intent and usage.

It is to be understood that the singular forms “a,” “an,” and “the” include plural references unless the context clearly dictates otherwise. Thus, for example, a reference to “a component surface” includes reference to one or more of such surfaces.

Embodiments described hereinafter relate to a screen change method of quickly changing the current screen to a previous or subsequent screen by a simple touch event in a touch screen portable terminal, and an apparatus therefor. A particular implementation will be described in which a currently displayed home screen of a home screen sequence is scrolled to reach a different home screen, in accordance with a touch gesture in a relatively fixed portion of the display screen. It is understood, however, that the present invention is not limited to the home screen applications described, and can be applied to other scrolling applications, such as those involving scrolling of data contents generated by an executed application.

As used herein, “screen” refers to the images appearing on a physical display, which images may only appear on a portion of the physical display. An example of a “screen” is a “home screen” or an “application execution screen”. “Touch screen” or “touch screen unit” refers to the physical display along with electronics to provide signals corresponding to touch events of the user on the physical display.

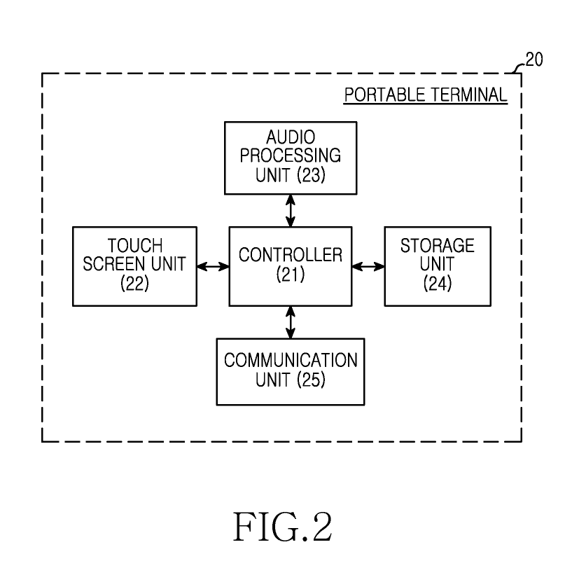

FIG. 2 is a functional block diagram illustrating configuration of a portable terminal according to one embodiment of the present invention. Portable terminal 20 includes a controller 21, a touch screen unit 22, an audio processing unit 23, a storage unit 24, and a communication unit 25.

The touch screen unit 22 includes a display to output an image under control of the controller 21, and touch screen electronics to output a touch signal of a user to the controller 21. Touch screen unit 23 can be a conventional touch screen unit, e.g., employing a resistive or capacitive type touch screen elements, as is well known in the art and thus need not be described in detail herein.

The controller 21 controls overall operations of the portable terminal 20, including the analysis of touch signals provided by touch screen unit 22 to determine a user's intentions. To this end, controller 21 detects X and Y coordinates at which touch contact is made on the screen 22 surface relative to X and Y coordinates of icons currently displayed, to determine whether a user has selected an icon to perform a corresponding function, e.g., launch an application upon selecting an icon for an application shortcut. In addition, controller 21 determines, via analysis of a sequence of touch signals, whether a particular type of touch gesture has been made. For instance, a “tap” gesture is detected if a touch signal indicates contact at a point on the screen surface followed by immediate release of the contact. A “touch drag” gesture is detected by detecting touch contact at a first point P1 on the screen surface, followed by continuous movement of the touch contact along the surface to a point P2 without releasing the touch. Controller 21 is configured to distinguish between different gestures such as a tap and a touch drag. As will be discussed further below, after a touch drag gesture is detected from a starting point P1 to an end point P2, if a release of the touch at P2 is detected, controller 21 may execute of a first operation. However if the touch is maintained at P2 for a predetermined length of time, controller 21 may execute a different operation. Thus controller 21 is further configured to distinguish a release of a touch drag from a “hold” of the touch drag.

The audio processing unit 23 outputs a voice signal of the user to the controller 21, or outputs a sound under control of the controller 21.

The storage unit 24 stores data pertaining to operations of the portable terminal 20, as well as programs for various applications executed within the portable terminal 20. The controller 21 includes at least one processor to execute a process of the present invention with reference to the data stored in storage unit 24. Particularly, the storage unit 24 stores a software package which includes an operating system, middleware, and basic applications which may drive a plurality of application programs. That is, storage unit 24 stores a software platform for operations of portable terminal 20, including a graphical user interface (GUI) program executed by controller 21 for implementing embodiments of the invention.

The communication unit 25 sets up an environment in which the portable terminal may smoothly perform wire or wireless communication.

The controller 21 sets an execution environment of the portable terminal, holds the set information, and drives the portable terminal stably. The controller 21 plays a role in allowing all devices of the portable terminal to smoothly input and output a data thereof. Also, the controller 21 may include a codec which converts an image signal through the touch screen unit 22 and a sound signal through the audio processing unit 23. Particularly, the controller 21 executes programs to provide a wireless Internet service, and applications and contents of the portable terminal based on the platform of the storage unit 24. The controller 21 provides an initial user interface screen of application shortcuts (e.g., icons), widgets, notice/status bars, etc. and allows the user to configure the screen. A plurality of screens may be configured.

Hereinafter, a description will be given with respect to a screen change method of a controller according to embodiments of the present invention with reference to the drawings.

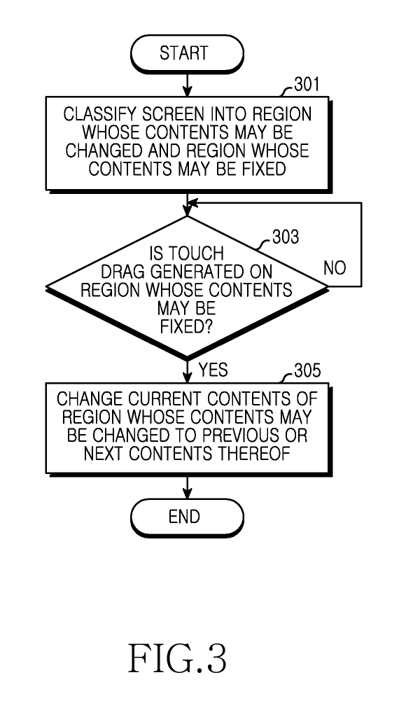

FIG. 3 is a flowchart illustrating a process of changing a screen in the portable terminal of FIG. 2, according to one embodiment of the present invention. At step 301, controller 21 classifies a screen into two regions. That is, the controller 21 classifies the screen into a region whose contents may be changed (hereafter, also referred to as “first region” or “scrollable contents region”, interchangeably) and a region whose contents may be fixed (hereafter, referred to as “second region” or “non-scrollable contents region”, interchangeably). When the screen is changed by scrolling, only the contents of the first region, and not those of the second region, are changed. Accordingly, a screen change means the change of the contents in the first region to a different set of contents in a contents sequence. The first region may provide application shortcuts and widgets, such those of a home screen. In other embodiments, the first region contains data provided by an executed application. The second region may provide application shortcuts and indicators which indicate menus, time, statuses, and conditions of an operation system of the touch screen portable terminal.

For example, a screen change may involve changing a first home screen of a home screen sequence to a second or higher number home screen of the sequence. That is, the first home screen is scrolled to a subsequent home screen.

In a screen change in the opposite direction, an “nth” home screen is scrolled to a (n-k)th home screen of the sequence, where k can be designated as an integer of 1 or more. K can also be designated as fractional in some implementations, which would allow for the display of an “in between” home screen, where a display of a home screen is scrolled to a display showing a portion of the current home screen and a portion of a next or previous home screen in the sequence.

With continuing reference to FIG. 3, if a touch drag gesture is sensed in the second region in step 303, the controller 21 proceeds to step 305 and provides previous or next contents in the contents sequence through the first region, in accordance with the direction of the touch drag. As will be explained hereafter, embodiments provide a variable scroll speed to previous or subsequent contents, where the scroll speed can be set based either on either a move distance of the touch drag gesture or an instantaneous or average speed of the touch drag gesture. In a portable terminal with many screens of a home screen sequence, for example, a user can scroll between the home screens at a user-controlled speed, and possibly scroll through all of the home screens with a single touch gesture.

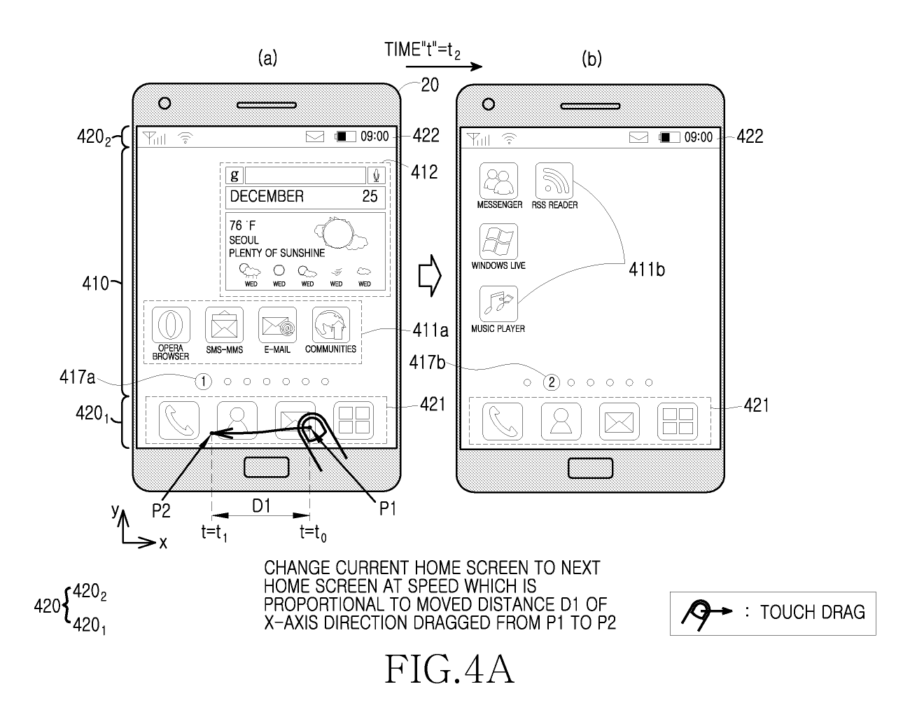

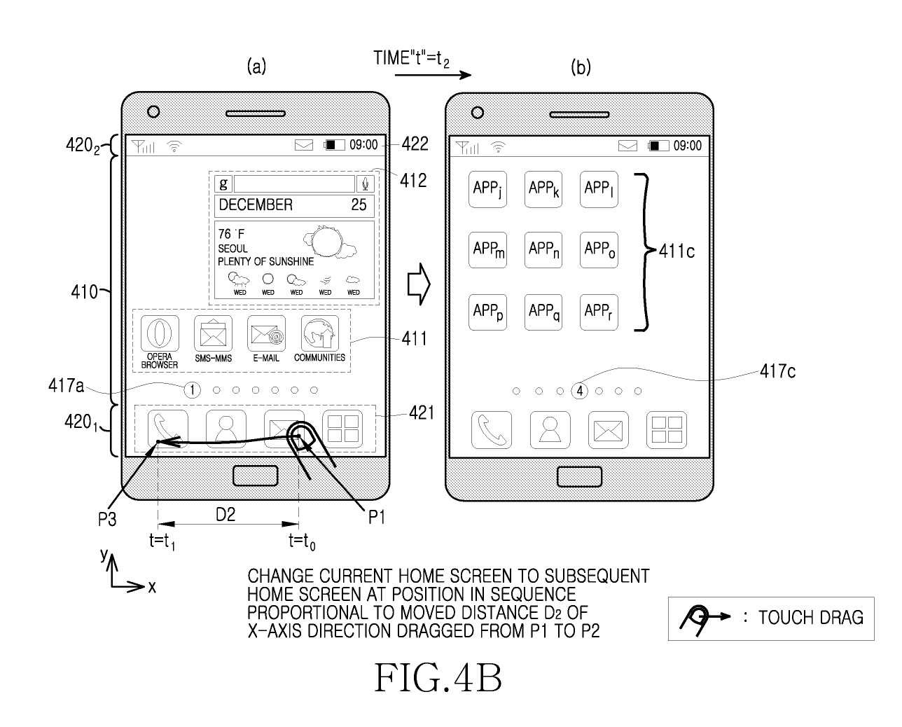

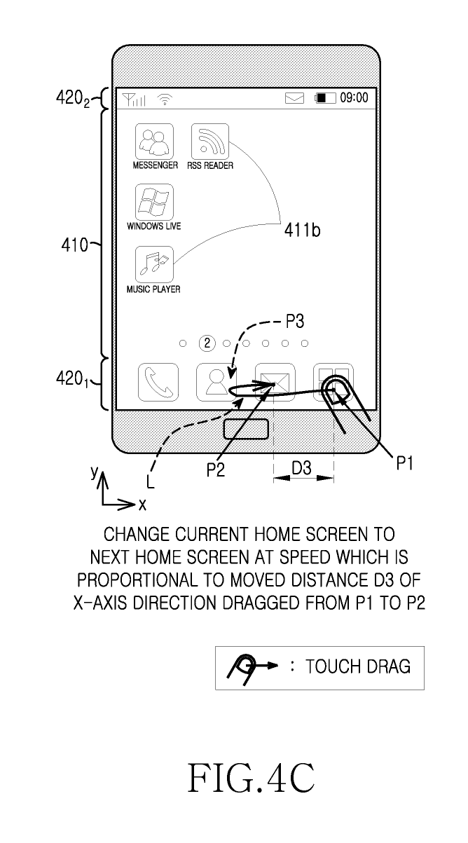

FIGS. 4A-4C, 5 and 6A-6B illustrate example user interface screens according to respective embodiments of the present invention. In these examples, a screen is changed to a previous or subsequent screen of a screen sequence or contents sequence according to a direction of a touch drag gesture. For example, if touch drag in the left direction is detected, a subsequent screen is provided. If touch drag in the right direction is detected, a previous screen is provided. (In an alternative design, a subsequent screen could be produced upon detecting a left direction touch drag, and a previous screen produced upon detecting a right direction touch drag.)

In some implementations, discussed further below, if touch contact is not released after a predetermined time following a touch drag gesture, scrolling may continue to further subsequent or further previous screens. For example, if touch drag is not released, screens can be sequentially changed.

Herein, each screen is classified into a first region 410 whose contents may be changed and a second region 420 (comprised of regions 420₁ and 420₂) whose contents may be fixed. That is, first region 410 displays scrollable contents; second region 420 displays non-scrollable contents. In the various figures, only the region 420₁ is used as an example of a region upon which touch gestures are made. However, it is understood that region 420₂ can additionally or alternatively be designated for this purpose. Note that contents in region 420₁ are preferably only semi-permanently fixed. That is, application shortcuts in region 420₁ (e.g., favorite shortcuts designated by the user) are preferably changeable to different shortcuts via a predetermined user command (i.e., a command that differs from a touch drag within region 420 described hereafter).

Referring to FIG. 4A, screen (a), the first region 410 may provide application shortcuts 411a, widgets 412, etc. The second region 420 may provide application shortcuts 421 in region 420₁ and indicators 422 in region 420₂ which indicate menus, time, statuses, and operation system conditions of the portable terminal 20. In general, if a single tap touch is generated on any of the application shortcuts 411a and 421, a corresponding application is executed.

Embodiments of the present invention may be applied to scroll through home screens of a home screen sequence at a user-controllable scroll rate. For instance, a symbol 417a in screen (a) is a circled numeral “1” indicating that the contents in first region 410 represents a first home screen of a home screen sequence. For instance, when portable terminal 20 is first turned on and “unlocked”, the first home screen may automatically appear. Or, if the portable terminal is executing an application, a predetermined command may be entered via a fixed key or the like on the terminal 20 to automatically change the display such that the first home screen is displayed.

Although not illustrated in the example screens, a “fixed” second region could be provided vertically, instead of or in addition to the fixed horizontal regions 420₁ and 420₂. In this case, if touch drag in the upper direction on the second region is detected, a previous screen can be displayed, and if touch drag in the lower direction is detected, a subsequent screen can be provided. (In an alternative design, an upper direction drag produces a subsequent screen and a lower direction touch drag produces a previous screen.) The user interface can be designed such that contents appear to be moving vertically during scrolling rather than horizontally as in the shown examples.

Referring to FIGS. 4A and 4B, if a touch drag gesture is detected on the second region 420, the controller 21 changes the current screen to a previous or next screen at a speed which is proportional to distance moved from a starting point P1 of the drag to an end point P2 thereof. For example, in an embodiment in which screen change is performed in left and right directions, a speed which is proportional to a moved distance D1 of an X-axis direction of touch drag may be applied to the screen change.

To illustrate this feature, in FIG. 4A, assume a touch drag gesture is detected from starting point P1 to point P2 on screen (a), which is a first home screen as indicated by the symbol 417a. The touch drag begins at time t=t0 and ends a short time thereafter at time t1. At time t1 and at point P2, the user releases the touch contact. Controller 21 detects the space-time characteristics of the touch gesture and in response, controls the touch screen to change its display to that of screen (b), which is the second home screen in the home screen sequence as indicated by symbol 417a. Home screen (b) displays an entirely different set of icons 411b than those of screen (a). The time taken to change from screen (a) to (b) is t2, where t2 is proportional to D1 and is measured from the time point t1 in this example.

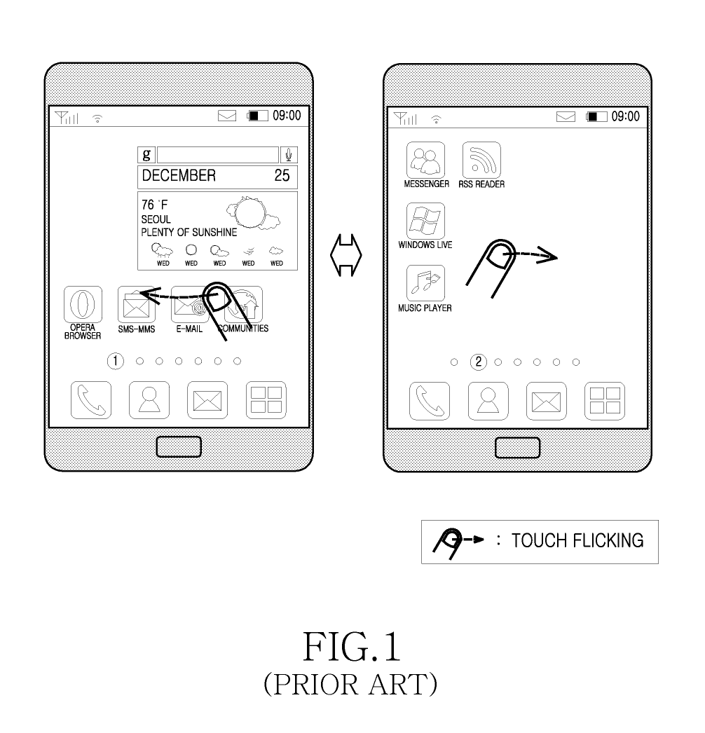

FIG. 4B illustrates a slightly different scenario in which the user performs a touch drag gesture from the same point P1 to a point P3 and then releases the touch contact, where point P3 is further to the left than point P2 of FIG. 4A. In this case, the distance D2 between the initial and ending touch points of the drag is larger than in the case of FIG. 4A. In response to this touch event, controller 21 changes the screen (a) to display the screen (c) by the time t2 elapses. Screen (c) is the fourth home screen in the example sequence as indicated by symbol 417c, and displays a different set 411c of icons APPj through APPr. (The time t2 represents the same value in FIGS. 4A and 4B). Thus the scroll speed between adjacent home screens of the home screen sequence is higher in the case of FIG. 4B than in FIG. 4A. Further, in FIG. 4B, the user has changed the display from the first to the fourth home screen using a single gesture. In the conventional technique illustrated in FIG. 1, the user would need a total of three touch drag gestures (three “flicks”) to scroll from the first to the fourth home screen.

It is noted that at a time point after t1 and before t2 in FIG. 4B, the in-between screens, i.e., the 2^{nd} home screen (b), and the 3^{rd} home screen, can each be momentarily displayed successively if the program is so designed. In addition, the scroll operation can be made to appear continuous, with interim screens containing portions of two adjacent screens during the scroll. Alternatively, the display can be just switched to the screen (c) instantaneously, upon detection a touch contact release after a touch drag distance D2.

In FIGS. 4A and 4B, it is assumed that the user releases touch contact at points P2 or P3. However, if the user maintains touch contact at a stopped point of the drag, controller 21 can be configured to implement a different display effect.

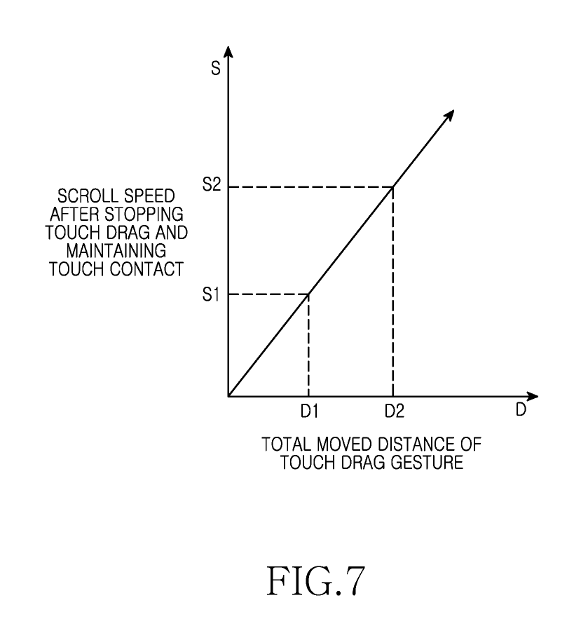

FIG. 7 is a graph showing scroll speed vs. touch drag distance illustrating a scroll feature according to certain embodiments of the present invention. In the example of FIG. 4A, if the user maintains touch contact at point P2 after the touch drag gesture over the distance D1, i.e., if the user stops the drag at P2 and holds the contact, the contents will continue to be scrolled a scroll speed S1 proportional to distance D1. That is, at time t2, screen (b) will be displayed as in the case of the touch release described above, but after another elapsed time t2, the next home screen (the third home screen) will be displayed, and so on. In the case of FIG. 4B, if the user maintains contact at point P3 following the touch drag over distance D2, the contents will continue to scroll at a faster speed S2 which is proportional to D2.

FIG. 4C illustrates an example screen that may result from a “reversal” gesture.

Assume that with the portable terminal 20 displaying the first (initial) home screen, the user began a touch drag from point P1 that continued to point P3, and then held the contact at P3 without release until a fourth or higher home screen was reached, as in the case of FIG. 4B. Thereafter, the user touch dragged back to point P2, all without releasing touch contact, as indicated by the loop back “L”. This operation caused an immediate reverse scroll, until the user was satisfied with the display of the second home screen, and then released touch contact to continue the display of the second home screen as shown.

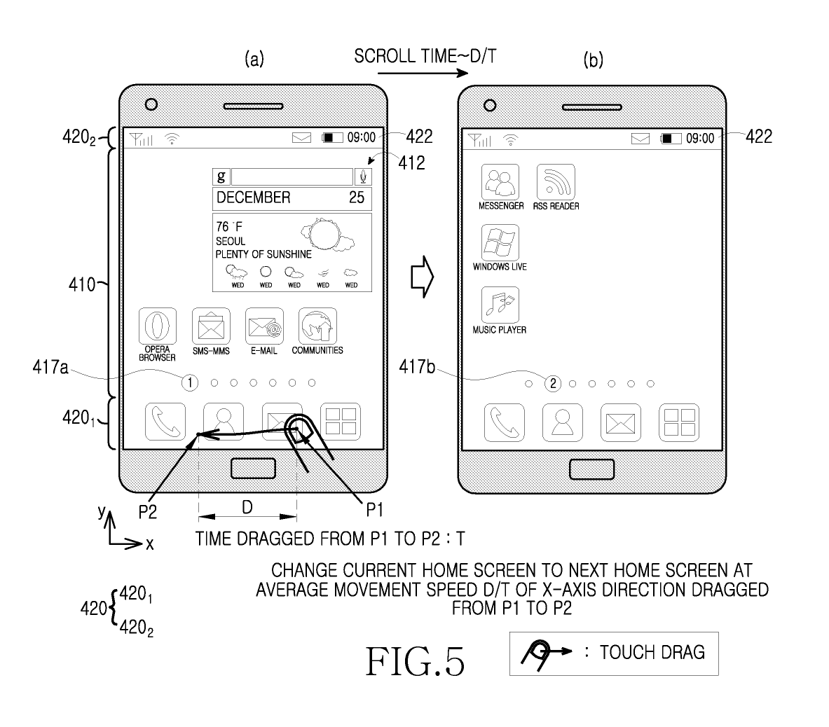

FIG. 5 is an example user interface screen according to another embodiment of the present invention. In this embodiment, if touch drag is generated on the second region 420 displaying non-scrollable contents, the controller 21 sets a scroll speed of contents in the first region 410 to be proportional to a speed of the touch drag on the second region. For example, the controller 21 calculates a speed from an X-axis moved distance D and an elapsed time T from a starting point P1 to an end point P2 of the drag and changes the currently displayed contents of the second region 410 to the previous or next contents thereof at the calculated speed. In the example, a first (initial) home screen (a) is scrolled to the second home screen (b) at a scroll time proportional to D/T. If the user then maintains contact at point P2, then, depending on the program design, scrolling can continue to subsequent home screens at the same scroll speed, or, the display can be held constant at the arrived upon home screen.

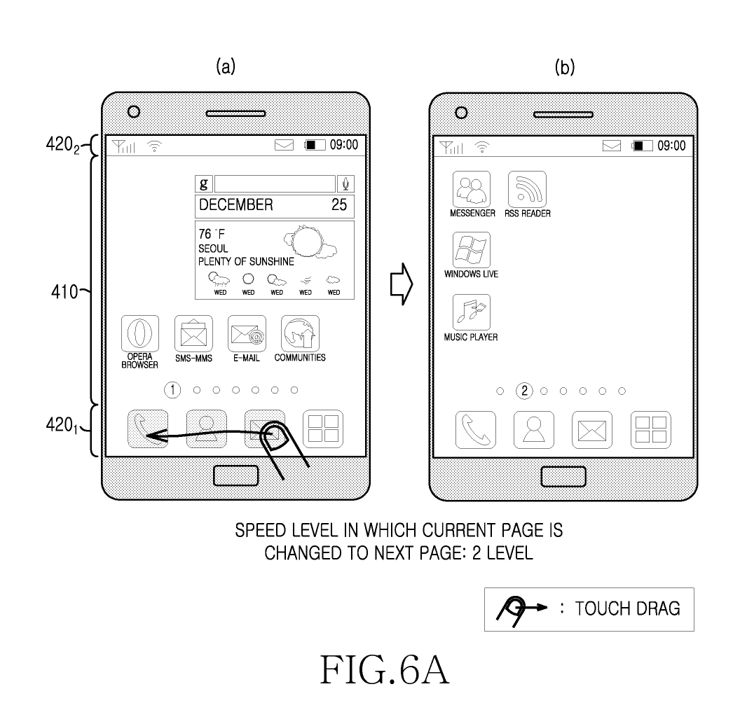

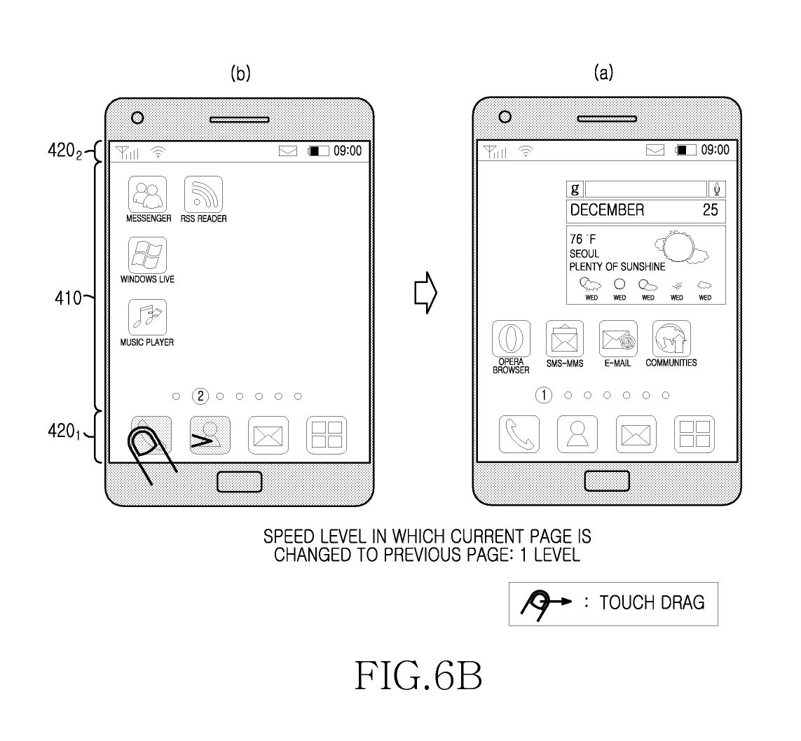

FIGS. 6A and 6B are user interface screens illustrating a further embodiment of the present invention. This embodiment is similar to that illustrated in FIGS. 4A-4C, except that instead of scroll speed being set according to absolute distance between the start and end of a touch drag gesture, scroll speed is set proportional to the number of icons (e.g., application shortcuts) through which a touch drag passes in the second region. As shown in the example of FIG. 6A, starting from an initial home screen, the controller 21 determines that a touch drag traverses a total of three application shortcuts, and controls a scroll speed at which home screen (a) changes to home screen (b) proportional to the number “3”. These results, for example, in a “Level 2” scroll speed. In the example of FIG. 6B, beginning at a second home screen (b), controller determines that a touch drag in the opposite direction traverses a total of two application shortcuts, such that a scroll speed is set proportional to “2”. This results in a “Level 1” scroll speed (e.g., half of the Level 2 speed).

In the embodiments of FIGS. 4A to 6B, scrolling of the first region 410 contents to previous or subsequent contents occurs in response to a touch drag in region 420. In addition, scrolling of the same contents is preferably implemented upon detecting a touch drag gesture within region 410 as well. Portable terminal 20 may be configured to achieve the latter scroll operation conventionally, as was shown in FIG. 1. In this case, the embodiments of FIGS. 4A-6B provide an additional scrolling option to the user.

Other embodiments of the present invention are applied to execution screens of an application within portable terminal 20. For example, when an application is executed, the controller 21 classifies the current screen into a fixed region (with non-scrollable contents) and a region displaying data. A “region displaying data” refers to a region for displaying a data written through the application or data which is being corrected through the application (such as in a word processing application). When a touch event such as touch drag and touch flicking is generated on the fixed region, the controller 21 changes the region displaying data to subsequent or previous data thereof and displays the changed data. In other words, the data within the region displaying data is scrolled in accordance with the touch drag gesture performed in the fixed region.

In conclusion, a screen change method of a touch screen portable terminal and an apparatus therefor according to embodiments of the present invention may allow a user to easily and quickly change a screen by a simple touch event.

It will be appreciated that embodiments of the present invention according to the claims and description in the specification can be realized in the form of hardware, software or a combination of hardware and software.

Any such software may be stored in a computer readable storage medium. The computer readable storage medium stores one or more programs (software modules), the one or more programs comprising instructions, which when executed by one or more processors in an electronic device, cause the electronic device to perform a method of the present invention.

Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention.

Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A screen change method of a touch screen portable terminal, the screen change method comprising:
classifying a screen into a first region displaying scrollable contents and a second region displaying non-scrollable contents; and
scrolling displayed contents of the first region to previous or subsequent contents of a contents sequence responsive to a touch drag gesture detected on the second region.

2. The screen change method of claim 1, wherein the contents displayed in the first region comprises at least one of application shortcuts and widgets.

3. The screen change method of claim 1, wherein the second region includes at least one of a region displaying favorite application shortcuts and a region displaying operating conditions of the portable terminal.

4. The screen change method of claim 1, further comprising:
detecting that the touch drag gesture has stopped at a point in the second region;
continuing to display the previous or subsequent contents if touch contact is detected to be released at the stopped point; and
continuing to scroll the displayed contents if the touch contact is detected to be maintained at the stopped point.

5. The screen change method of claim 1, wherein the scrolling of displayed contents comprises:
providing the subsequent contents when touch drag in one of a left and right direction is generated, and providing the previous contents when touch drag in the other of the left and right direction is generated, and/or providing the subsequent contents when touch drag in one of an upper and lower direction is generated and providing the previous contents when touch drag in the other of the upper and lower direction is generated.

6. The screen change method of claim 1, wherein the scrolling is performed at a speed proportional to a moved distance of the touch drag gesture.

7. The screen change method of claim 1, wherein the scrolling is performed at a speed proportional to a speed of the touch drag gesture.

8. The screen change method of claim 1, wherein the scrolling is performed at a speed proportional to a number of application shortcuts in the second region through which the touch drag gesture passes.

9. The screen change method of claim 1, wherein the scrollable contents displayed in the first region is data according to execution of an application, the data being scrolled according to the touch drag gesture.

10. The screen change method of claim 9, wherein the application is a word processing application and the data is data written by the application.

11. A screen change apparatus for a portable terminal, the screen change apparatus comprising:
a touch screen unit that displays an image and outputs a signal according to touch input;
a storage unit storing operations data of the portable terminal; and
a controller configured to classify a screen provided through the touch screen unit into a first region displaying scrollable contents and a second region displaying non-scrollable contents and to control scrolling of the scrollable contents to previous or subsequent contents of a contents sequence responsive to a touch drag gesture detected on the second region.

12. The screen change apparatus of claim 11, wherein the scrollable contents displayed in the first region comprises at least one of application shortcuts and widgets.

13. The screen change apparatus of claim 11, wherein the controller designates at least one of a region displaying favorite application shortcuts and a region displaying operating conditions of the portable terminal are displayed as the region whose contents are fixed.

14. The screen change apparatus of claim 11, wherein the controller is further configured to:
detect that the touch drag has stopped at a point in the second region;
continue to cause the display of the previous or subsequent contents if touch contact is detected to be released at the stopped point; and
continue to scroll the displayed contents if the touch contact is detected to be maintained at the stopped point.

15. The screen change apparatus of claim 11, wherein the controller provides the subsequent contents when touch drag in one of a left and right direction is detected and provides the previous contents when touch drag in the other of the left and right direction is detected, and/or provides the subsequent contents when touch drag in one of an upper and lower direction is detected and provides the previous contents when touch drag in the other of the upper and lower direction is detected.

16. The screen change apparatus of claim 11, wherein the controller sets a speed at which the contents are scrolled to a speed proportional to a moved distance of the touch drag gesture.

17. The screen change apparatus of claim 11, wherein the controller sets a speed at which the contents are scrolled to a speed proportional to a speed of the touch drag gesture.

18. The screen change apparatus of claim 11, wherein the controller sets a speed at which the contents are scrolled to a speed proportional to a number of application shortcuts through which the touch drag gesture passes in the second region.

19. The screen change apparatus of claim 11, wherein the scrollable contents in the first region is data provided according to the execution of a word processing application, the data being scrolled according to the touch drag gesture.

20. A non-transitory computer readable recording medium storing program instructions which, when executed within a portable terminal, cause the portable terminal to perform the method of claim 1.
